(19) United States
(12) Patent Application Publication
(10) Pub. No.: US 2025/0224535 A1
(43) Pub. Date: Jul. 10, 2025

(54) Method for a Detection Device; Detection Device

(71) Applicant: Robert Bosch GmbH, Stuttgart (DE)

(72) Inventors: Heiko Sgarz, Leonberg (DE); Jan-Michael Brosi, Leinfelden-Echterdingen (DE); Frank Wolter, Renningen (DE); Andreas Vogt, Renningen (DE)

(21) Appl. No.: 18/854,003

(22) PCT Filed: Apr. 4, 2023
(86) PCT No.: PCT/EP2023/058771

§ 371 Date: Oct. 3, 2024

(30) Foreign Application Priority Data
Apr. 11, 2022 (DE) 10 2022 203 605.0

(51) Int. Cl. G01V 3/38; G01V 3/12; G06N 20/10

(52) U.S. Cl. CPC G01V 3/38; G01V 3/12; G06N 20/10

(57) ABSTRACT

A method for operating a detection device includes providing a detection device configured to non-destructively acquire a detection signal from an object arranged within an underground examination region. The method further includes assigning the detection signal to a detection result based on a machine learning process, in order to output the detection result and/or to use this to adjust the detection device.

### PRIOR ART

A method for a detection device, wherein the detection device is provided to non-destructively acquire a detection signal from an object arranged within an underground examination region has already been proposed.

### DISCLOSURE OF THE INVENTION

The invention proceeds from a method for a detection device, wherein the detection device is provided to non-destructively acquire a detection signal from an object arranged within an underground examination region.

It is proposed that the detection signal is assigned to a detection result on the basis of a machine learning process in at least one method step of the method, in order to output the detection result and/or to use this to adjust the detection device. The method preferably comprises an application phase. In the application phase, in at least one detection step of the method, the detection signal is acquired by a sensor unit of the detection device. In the application phase, the detection signal is evaluated by an evaluation unit in at least one evaluation step of the method. The evaluation unit is preferably a computing unit of the detection device or, alternatively, an external computing system comprising a data connection, in particular radio-wave-based, to the detection device, in particular an Internet server. In the application phase, the detection result is preferably output from an output unit of the detection device and/or from an external output device, for example a smartphone, a tablet, or the like, to a user of the detection device. Additionally or alternatively, in the application phase, the detection result is used by the computing unit of the detection device in an adjusting step of the method in order to change a setting of the detection device, in particular to repeat the detection step with a setting of the detection device, in particular the sensor unit, matched to the object and/or the background.

The method preferably comprises a teach-in phase. In the teach-in phase, in a data retrieval step of the method, example values (so-called training data) are collected for the detection signal. The example values may be acquired by the sensor unit of the detection device, acquired by a sensor unit of a further detection device, generated by a simulation, read from logged datasets, and/or the like. In a learning step of the teach-in phase, the example values are processed from the machine learning process to a model that maps the detection signal to the detection result. The machine learning process is preferably performed by a learning unit. The learning unit is preferably an, in particular the already mentioned, external computing system, alternatively the computing unit of the detection device or a further external computing system, for example a private server. Optionally, the method comprises a provisioning step in which the model generated with the machine learning process is transferred to the detection device after the teach-in phase and stored in a memory of the evaluation unit, in particular the calculating unit of the detection device. Preferably, in the application phase, the evaluation unit uses the model generated with the machine learning process in order to perform the evaluation step. The teach-in phase may be completed before the application phase or may overlap in time with the application phase, wherein the example values on which the model is based are in particular supplemented by the measured values of the detection signal acquired in the application phase.

The machine learning process is an algorithm from the machine learning area, preferably to create the model based on the example values. The machine learning process preferably comprises a neural network and/or a classification method. The machine learning process may include supervised learning and/or unsupervised learning. The method preferably comprises an assignment step in which example values of the detection signal are assigned at least one evaluation parameter. The detection result may be identical to an evaluation parameter, comprise a plurality of evaluation parameters, or be determined as a function of the evaluation parameters. The evaluation parameter, in particular the entirety of evaluation parameters, for an example value specifies the detection result to which the model should map this example value in the case of supervised learning during the learning process. For unsupervised learning, the evaluation parameter is subsequently assigned to a structure determined by the learning process in the example values. The assignment step may be performed manually or may be performed automatically as part of the data retrieval step. For example, the evaluation parameter may describe a condition of the underground examination region, a type of the object, a size of the object, a depth of the object in the underground examination region, or the like. The evaluation parameter may be known, for example, if an example value for the detection signal on a known underground examination region with a known object is acquired. For example, the underground examination region and/or the object may be determined by recreating a collection situation with the detection device in a laboratory or by computer-based simulation of the collection situation and/or may be taken from a construction plan. The evaluation parameter may be acquired, for example, by an external sensor device, which comprises other, in particular invasive and/or more precise sensors, than the sensor unit of the detection device and/or sensors which cannot be integrated into the detection device due to the limited installation space of the detection device.

During the application phase, the detection device is in particular provided to be applied and/or moved on the underground examination region in order to detect the object. “Non-destructive” should be understood to mean in particular without permanent change, in particular without damage, to the underground examination region and the object. In particular, the detection device senses the object non-invasively. Preferably, the sensor unit generates a signal in the detection step and emits it into the underground examination region, in particular as an electromagnetic wave or as an electromagnetic field, wherein the sensor unit detects a change, in particular a backscattering, of the signal through the underground examination region and/or the object as a detection signal. Alternatively or additionally, the detection device is provided to acquire a signal emanating from the object as a detection signal. For example, the detection device is provided to detect a metal object, a non-metallic object, an electrical line, in particular a low-voltage line, a single-phase alternating current line or a three-phase current line, a wood beam, a metal carrier or a plastic tube, in particular a water-filled plastic tube or a non-water-filled plastic tube, or the like, as an object. The underground examination region is, for example, a wall, a ceiling, a floor, or a fixture of a building.

The detection signal can advantageously be evaluated in detail by means of the embodiment according to the invention. In particular, additional information included in the detection signal beyond a mere presence or non-presence of the object may be advantageously reliably extracted from the detection signal. By using the additional information, operation of the detection device can advantageously be kept simple and/or a user of the detection device can be provided with an advantageously large amount of information with, in particular, only a single measurement with the detection device. In addition, an advantageously reliable repeatability of the detection result can be achieved and, in particular, a dependency of the detection result on a travel path of the detection device on the underground examination region can be advantageously minimized.

It is further proposed that in a learning phase of the machine learning process, in particular the one already mentioned, example values for the detection signal are divided into different groups as a function of cluster formation of the example values. Preferably, the teach-in phase comprises a pre-processing step in which the learning unit prepares the example data prior to the learning step. In the pre-processing step, the learning unit preferably performs unsupervised learning in order to divide the example values into the groups. Preferably, in the pre-processing step, the learning unit divides the example values into at least two different groups. The learning unit determines the groups as well as a membership of the example values to these groups, preferably by means of a cluster method. Preferably, in the pre-processing step, the learning unit extracts at least one feature, preferably multiple features, from each example value to be processed. For example, the feature may be a physical variable, a statistical variable, or an abstract key figure of the example value. If example values have similar values for the feature/all features, the learning unit assigns the example values preferably to the same group. If example values have different values for the feature/one of the features, the learning unit preferably assigns the example values to different groups. Whether values of the features are similar or different is defined by the cluster method used. The embodiment according to the invention allows example values that are similar to one another in terms of the extracted features to be combined and processed together. In particular, with advantageously low error risk, all example values within the same group may be assigned the same evaluation parameters. In particular, the time required to perform the assignment step may be advantageously kept short. In particular, an example value acquired in an unknown collection situation may be assigned an evaluation parameter of an example value of the same group that was acquired in a known collection situation.

Furthermore, it is proposed that the machine learning process, in particular in the pre-processing step, uses a nearest neighbor classification to perform a division into different groups. Particularly preferably, the learning unit uses a K-nearest neighbor (KNN) algorithm to perform the division into the different groups. In particular, the learning unit assigns an example value to a group depending on which group the majority of the neighboring example values have been assigned to. Neighboring example values are defined as a set number of example values that have the least distance to the example value to be divided into a parameter space spanned by the features. The distance between two example values in the parameter space spanned by the features may be determined using the Euclidean metric, the Manhatten metric, or another metric. The number of neighboring example values used may be defined by an operator of the learning unit and/or determined using an optimization algorithm. Optionally, in the case of a majority decision of the neighboring example values, a voting share of the example values is weighted, in particular with the respective distance of the neighboring example values from the example value to be divided. Alternatively, the example values are divided into different groups by means of a cuboid classifier, a distance classifier, a polynomial classifier, or another classifier. The embodiment according to the invention allows an advantageously reliable division of the example values into the groups.

Furthermore it is proposed that in a teach-in phase of the machine learning process, in particular the aforementioned example values for the detection signal, an evaluation parameters, in particular the aforementioned evaluation parameter(s), is/are assigned in groups. Preferably, at least one example value is selected from each group as the representative for the group. The representative is an example value whose evaluation parameters are known by readjustment, simulation or from other sources. Preferably, the learning unit assigns the evaluation parameter or the evaluation parameters that are assigned to the representative to all example values within the group of the representative. The representative may be added to the remaining example values in the data retrieval step or may be determined after a division of the remaining example values into the groups. Optionally, the learning unit uses the representatives and/or domain knowledge as supporting points for the nearest neighbor classification. Alternatively, the number of groups is automatically determined, for example by varying the initial cluster centers and minimum sum distances. The embodiment according to the invention can advantageously minimize the duration of the assignment step. In particular, an advantageously large number of example values can be used for the machine learning process, the evaluation parameters of which have not been acquired in detail.

In addition, it is proposed that in a teach-in phase of the machine learning process, in particular the one already mentioned, a dataset of example values for the detection signal consists at least substantially of user data. “Substantially” is to be understood in particular to mean more than 30°%, preferably more than 60%, more than 90%, most preferably more than 99%. Preferably, in addition to the user data, the dataset comprises the representatives of the groups. “User data” is to be understood in particular to mean detection signals that are acquired by a user in the application phase with the detection device or a further detection device, in particular in a real, i.e. not readjusted or simulated, collection situation. Preferably, user data is collected from a plurality of detection devices to form the dataset. In particular, the user data is automatically transmitted from a data interface of the detection device to the learning unit. The embodiment according to the invention can advantageously minimize the time and a cost requirement for readjusting and/or simulating collection situations. Furthermore, the example values advantageously include many real and not only ideal collection situations, which cannot be reproduced in the laboratory, particularly in terms of their complexity and/or diversity. In particular, an advantageously robust model may be created with the machine learning process.

Furthermore, it is proposed that, in at least one method step, an operating mode of the detection device is automatically selected as a function of the machine learning process. The detection device, in particular the sensor unit, comprises at least one operating mode provided for a particular collection situation and at least one further operating mode provided for a further collection situation. Collection situations differ, for example, due to different materials or designs of the underground examination region and/or different types of the detected object. The operating modes differ, for example, by a sensor element used by the sensor unit and/or by a signal parameter of the emitted signal, such as intensity, frequency, duration or the like. Preferably, the sensor unit detects an initial detection signal in a collection situation, which is evaluated by the evaluation unit to produce an initial result. Preferably, the evaluation unit, in particular the computing unit of the detection device, selects one of the operating modes based on the initial result in order to perform all subsequent detection steps in the same collection situation in the selected operating mode. Preferably, a table is stored in a memory of the evaluation unit, in particular the computing unit of the detection device, which assigns the operating modes to the initial result and is read by the evaluation unit to select the operating mode. Alternatively, the detection result comprises the operating mode provided for the collection situation as an evaluation parameter and is learned in the course of the machine learning process. The embodiment according to the invention allows an advantageously simple and intuitive operation of the detection device to be achieved. In particular, adjustment of the detection device by a user may be omitted. In particular, the number of necessary operating elements of the detection device and/or menu items of a graphical user interface of the detection device can be advantageously minimized. In particular, a risk of incorrect operation of the detection device by a user may be advantageously minimized.

Furthermore, it is proposed that, in at least one method step, a zero reference for the detection signal is automatically selected as a function of the machine learning process. The zero reference is a measured value of the detection signal when the underground examination region is free of detectable objects. Preferably, the evaluation unit evaluates a difference between the detection signal and the zero reference in order to determine whether an object is present in the underground examination region or not. The zero reference typically depends on the material and design of the underground examination region. In particular, the different operating modes of the detection device have different zero references. The zero reference(s) are preferably part of the model created by the machine learning process. In particular, in the assignment step, a zero reference is assigned to each example value, in particular each group of example values. Alternatively, the zero references are stored as a table in a memory of the computing unit and are read by the computing unit as a function of the selected operating mode. As a result of the embodiment according to the invention, a separate determination of the zero reference by a user of the detection device can be omitted. In particular, the detection device may be used advantageously quickly to detect an object after turning on. In particular, a risk of incorrect operation of the detection device may be advantageously minimized.

It is further proposed that, in at least one method step, the detection device outputs an evaluation parameter, in particular the aforementioned evaluation parameter, of a group, in particular the aforementioned group, of example values of the detection signal when a measured value of the detection signal is assigned to this group. The evaluation unit assigns the evaluation parameters to the measured value by means of the model. The output unit preferably outputs at least whether an object is detected or whether no object is detected. The output unit preferably outputs the evaluation parameter in addition to the information as to whether an object is detected or not. For example, the output unit outputs a material or a design of the underground examination region as the evaluation parameter. For example, the output unit outputs the type of the detected object, the size of the detected object, in particular, a maximum extension of the detected parallel to a surface of the underground examination region, a distance of an edge of the detected object to a current measuring point of the detection device, in particular parallel to the surface of the underground examination region, and/or the like as evaluation parameters. The embodiment according to the invention allows a user to be provided with an advantageous amount of information, in particular with a single measurement.

Furthermore, a detection device is proposed with at least one sensor unit, in particular the aforementioned sensor unit, for detecting a detection signal, in particular the aforementioned detection signal, and with at least one computing unit, in particular the aforementioned one, for performing a method according to the invention. The sensor unit comprises at least one sensor element. Optionally, the sensor unit comprises a plurality of, in particular differently configured, sensor elements. Examples of sensor elements of the sensor unit include a radar, in particular a narrowband radar, in particular in a frequency range from 2.4 GHz to 2.4835 GHz, and/or an ultra-wideband radar, an inductive sensor, a capacitive sensor, an AC current sensor, in particular a 50 Hz AC sensor and/or a 60 Hz AC sensor, or the like. The term “computing unit” is understood in particular to mean a unit having an information input, information processing, and an information output. Advantageously, the computing unit comprises at least one processor, a storage, input and output means, further electrical components, an operating program, regulating routines, control routines, and/or calculation routines. The components of the computing unit are preferably arranged on a common board and/or advantageously arranged within a common housing. Preferably, the detection device comprises the output unit to an output of the detection result. For example, the output unit comprises a display, a microphone, a vibration alarm, or the like to output the detection result. Preferably, the detection device comprises the data interface. The data interface may comprise a wired and/or radio wave-based interface element, in particular a Bluetooth interface, a WLAN interface, an Ethernet interface, or the like. The data interface is provided for outputting the detection result on the external output device, for forwarding the detection signal to the external computing system and/or for receiving the model from the external computing system.

The embodiment according to the invention can provide a detection device which is advantageously easy to operate and/or which advantageously provides a lot of information.

The method according to the invention and/or the detection device according to the invention should not be limited to the application and embodiment described above. In particular, the detection device according to the invention and/or the method according to the invention can have a number of individual elements, components and units as well as method steps that differs from a number mentioned herein in order to fulfil an operating mode described herein. Moreover, regarding the ranges of values indicated in this disclosure, values lying within the limits specified hereinabove are also intended to be considered as disclosed and usable as desired.

### DRAWINGS

Further advantages follow from the description of the drawings hereinafter. The drawings show an exemplary embodiment of the invention. The drawings, the description, and the claims contain numerous features in combination. A person skilled in the art will appropriately also consider the features individually and combine them into additional advantageous combinations.

The figures show:

FIG. 1 a schematic diagram of a detection device according to the invention,

FIG. 2 a schematic flow chart of a method according to the invention,

FIG. 3 a schematic division of a dataset of example data in the course of a machine learning process of the method according to the invention.

### DESCRIPTION OF THE EXEMPLARY EMBODIMENT

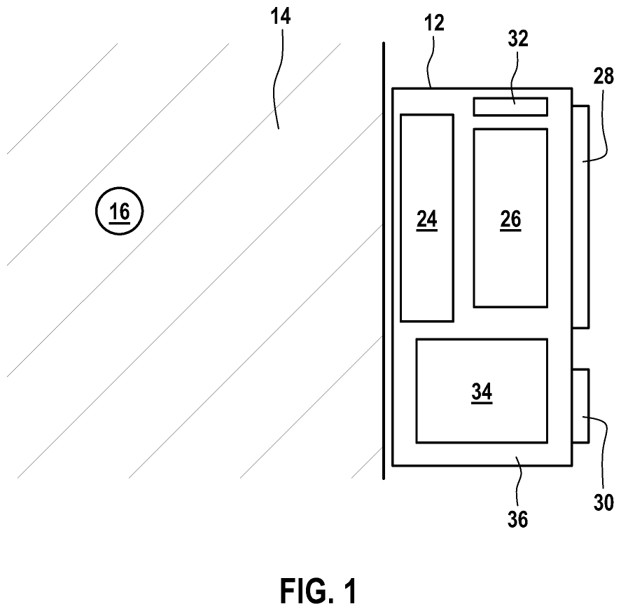

FIG. 1 shows a detection device 12. The detection device 12 is shown arranged on a surface of an underground examination region 14, for example a wall. The detection device 12 is provided to non-destructively acquire a detection signal from an object 16 arranged within the underground examination region 14. The detection device 12 is preferably designed to be held by hand, preferably by one hand and in particular can be operated with the same hand. Particularly preferably, the detection device has a total volume of less than 7000 cm³, preferably less than 5000 cm³, particularly preferably less than 3000 cm³. The detection device 12 comprises a sensor unit 24 for acquiring the detection signal. The sensor unit 24 preferably comprises at least one sensor element which is provided for emitting an electromagnetic signal into the underground examination region 14 and for detecting a portion of the emitted signal scattered back by the object 16 as a detection signal. Alternatively or additionally, the sensor unit 24 comprises a capacitive sensor and/or an inductive sensor for acquiring the detection signal. The detection device 12 comprises a computing unit 26 for evaluating the detection signal to produce a detection result.

Preferably, the detection device 12 comprises an output unit 28 for outputting the detection result. The output unit 28 preferably comprises a display for indicating the detection result. Preferably, the detection device 12 comprises at least one data interface 32 for exchanging data with an external computing system and/or an external output device. The detection device 12 preferably comprises a power supply unit 34 for supplying electrical power to the sensor unit 24, the computing unit 26, the output unit 28 and/or the data interface 32. The power supply unit 34 is in particular provided for receiving at least one battery and/or an accumulator. The detection device 12 preferably comprises at least one control element 30, for example a switch, a button, a slider or the like, for operating the detection device 12, in particular for triggering a detection with the detection device 12. The detection device 12 comprises a housing 36 within which at least the sensor unit 24 is arranged. Preferably, the computing unit 26, the data interface 32 and/or the power supply unit 34 are arranged in the housing 36. Preferably, the output unit 28 and/or the control element 30 is arranged on the housing 36 or embedded in the housing 36. The external computing system and/or the external output device are preferably configured independently of the detection device 12 (not shown here).

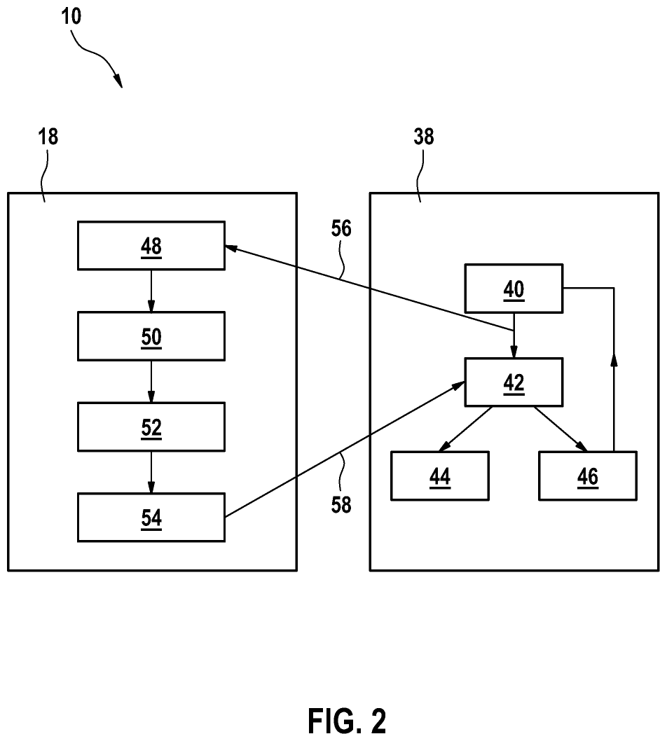

FIG. 2 shows a flow chart of a method 10 for the detection device 12. The method 10 preferably comprises a detection step 40 in which the sensor unit 24 acquires the detection signal. The method 10 comprises an evaluation step 42 in which the detection signal is evaluated as a function of a machine learning process to produce the detection result. The method 10 in particular comprises an output step 44 in which the detection result is output. The method 10 preferably comprises an adjustment step 46 in which the computing unit 26 changes an adjustment of the detection device 12, in particular the sensor unit 24 and/or the computing unit 26, as a function of the detection result.

The method 10 preferably comprises an application phase 38. The application phase 38 is preferably carried out entirely, alternatively in part, by means of the detection device 12. The application phase 38 preferably comprises the detection step 40, the evaluation step 42, the output step 44, and/or the adjustment step 46. In particular, the evaluation step 42 is carried out by the computing unit 26. Alternatively, the evaluation step 42 is carried out by one, in particular the aforementioned or a further, external computing system. The outputting step 44 is preferably performed by the output unit 28. Alternatively, the outputting step 44 is performed by the external output device. In particular, in the alternative embodiments, the data interface 32 emits the detection signal to the further external computing system, receives the detection result from the external computing system and/or sends the detection result to the external output device.

The method 10 preferably comprises a teach-in phase 18. The teach-in phase 18 is preferably carried out by the external computing system, alternatively by the computing unit 26. In the teach-in phase 18, a model is created using the machine learning process, which maps the detection signal to the detection result. The model is stored in a provisioning step 58 in a memory of the computing unit 26 of the detection device 12. In particular, in the evaluation step 42, the computing unit 26 applies the model in order to convert a measured value of the detection signal acquired by the sensor unit 24 into the detection result.

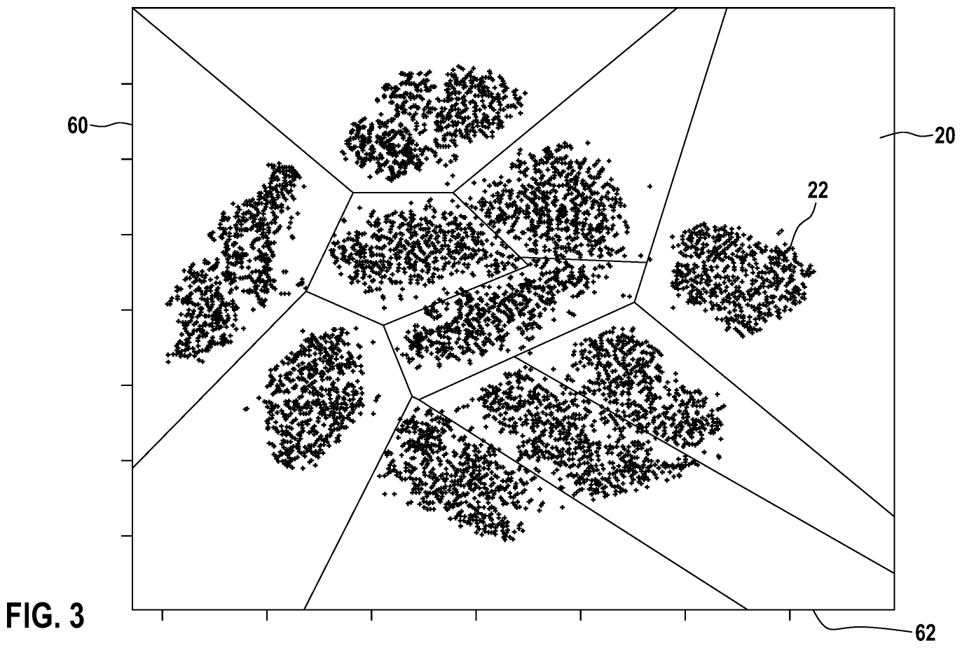

The teach-in phase 18 preferably includes a data retrieval step 48. In the data retrieval step 48, example values 22 (see FIG. 3) are acquired, which are processed to create the model. Preferably, the method 10 comprises a collection step 56 in which measured values of the detection signal acquired by the sensor unit 24 are collected as example values 22. Preferably, the data interface 32 transmits the measured values acquired by the sensor unit 24, in particular collected or individually, to the external computing system in the collection step 56. Particularly preferably, the external computing system collects measured values from a variety of detection devices, particularly in the context of an Internet of Thing (IoT) concept. A dataset of the example values 22 for the detection signal consists at least substantially of user data. User data are measured values of the detection signal captured by users in application phase 38 using the detection device 12. Preferably, in the data retrieval step 48, example values 22 are additionally determined as representatives by the manufacturer of the detection device 12. For example, the representatives are determined by detection with the detection device 12 on a replica of different underground examination regions 14 including different objects 16 and/or created by simulating detection steps 40 on different underground examination regions 14 including different objects 16. Preferably, the dataset comprises at least 10 times, preferably at least 100 times, particularly preferably at least 1000 times more user data than representatives.

The teach-in phase 18 preferably comprises a pre-processing step 50. In the pre-processing step 50, the example values 22 are evaluated with regard to at least one feature 60, 62, preferably several features 60, 62 (cf. FIG. 3). The at least one feature 60, 62 is preferably provided as a discriminating criterion by means of which the external computing system evaluates whether two example values 22 are the same or different. Features 60, 62 of the example values may be, for example, an intensity of the detection signal, a ratio of the backscattered fraction to the emitted fraction of the detection signal, a mean of the detection signal, an extreme of the detection signal, a time duration of an amplitude modulation of the detection signal caused by the object, a range of variation of the detection signal, or the like. The example values 22 for the detection signal are divided into different groups 20 by the external computing system as a function of cluster formation of the example values 22. The external computing system evaluates the cluster formation of the example values 22, preferably based on the determined features 60, 62. In particular, the external computing system determines whether a distribution of the example values 22 within a parameter space spanned by the at least one feature 60, 62 has clusters. A dimensionality of the parameter space is equal to the number of different features 60, 62 per example value 22. A distribution of the example values 22 in a two-dimensional parameter space spanned by a feature 60 and a further feature 62 is shown as an example in FIG. 3. Preferably, the external computing system assigns the example values 22 forming a cluster to the same group 20. Preferably, the external computing system assigns example values 22 that form different clusters to different groups 20. In FIG. 3, example values 22 have been subdivided into ten groups 20, by way of example. The external computing system uses a nearest neighbor classification in order to perform a division of the example values 22 into the different groups 20.

The method 10 preferably comprises an assignment step 52. In the assignment step 52, the example values 22 for the detection signal are assigned at least one evaluation parameter in groups. Preferably, at least one evaluation parameter is assigned to each group 20. Optionally, at least one group 20 is assigned a plurality of evaluation parameters. Two different groups 20 differ from each other by at least one of the evaluation parameters assigned to them. The at least one evaluation parameter is processed by the machine learning process, in particular as an intermediate result to be learned or as an end result to be learned. Preferably, an underground examination region is assigned to the groups 20 as an evaluation parameter, which describes or characterizes the underground examination region 14. For example, the underground parameter includes the values: Concrete, light construction, dry construction, in particular thickness and/or number of plasterboard panels and/or wood panels of light construction or dry construction, brick wall, in particular brick type of the brick wall, presence of a floor heating or wall heating, or the like. Preferably, an object type parameter is assigned to the groups 20 as evaluation parameters, which describes or characterizes the type of object 16. For example, the object type parameter includes the values: Metal, non-metal, live, non-powered, magnetic, non-magnetic, low voltage cable, single phase AC power cable, in particular between 110 V and 230 V, multi-phase AC cable, three phase power cable, wood beams, metal support, plastic tube, water filled tube, in particular fresh water tube, non-water filled tube, in particular waste water pipe. Preferably, a depth parameter is assigned to the groups 20 as the evaluation parameter, which describes or characterizes a distance of the object 16 to a surface of the underground examination region 14. The depth parameter may indicate the distance continuously or in regions. Preferably, a shape parameter is assigned to the groups 20 as an evaluation parameter, which describes or characterizes a shape or extension of the object 16. For example, the shape parameter indicates a diameter of the object 16. The assignment step 52 is performed by the external computing system by means of the representatives. The evaluation parameters of the representatives can be acquired by the manufacturer of the detection device 12, for example with a sensor device independent of the detection device 12 on the replicas, read from data sheets for the replicas or read from a simulation program and stored in a memory of the external computing system. Preferably, the external computing system determines at least one representative to each group 20, reads their evaluation parameters from the memory of the external computing system and assigns these evaluation parameters to all example values 22 in the same group 20 as the representative. If there are multiple representatives with different evaluation parameters in the same group 20, the external computing system optionally performs a further subdivision of these groups 20 into subgroups.

In particular, the teach-in phase 18 includes a learning step 54. In the learning step 54, the external computing equipment creates the model using the machine learning process. In particular, the external computing system uses the example values 22 as input values of the model and the evaluation parameters assigned to the example values 22 as the output value of the model. The detection result consists in particular of the entirety of the evaluation parameters or is determined as a function of the evaluation parameters. In the provisioning step 58, the external computing system emits the model to the computing unit 26 of the detection device 12 via the data interface 32.

In the application phase 38, the computing unit 26 of the detection device 12 uses the model in order to automatically select an operating mode of the detection device 12. Preferably, in the detection step 40, the sensor unit 24 acquires an initial detection signal, which is evaluated in the evaluation step 42 to produce an initial result. The computing unit 26, in particular, determines the underground examination region as a function of the initial detection signal by means of the model in order to automatically select a zero reference for the detection signal as a function of the machine learning process in the adjusting step 46. The computing unit 26, in particular, determines the object type parameter, the depth parameter and/or the shape parameter as a function of the initial detection signal by means of the model in order to increase a sensitivity of the sensor unit 24 for the object 16 in the adjusting step 46 and/or to avoid oversaturation of the sensor unit 24.

In the application phase 38, the detection device 12 outputs in the output step 44 the at least one evaluation parameter of the group 20 of example values 22 of the detection signal when the model assigns a measured value of the detection signal to this group 20. The output unit 28 preferably outputs whether the object 16 has been detected. The output unit 28 preferably outputs the object type parameter and the underground parameter. The output unit 28 optionally outputs the depth parameter and/or the shape parameter.

1. A method for operating a detection device, comprising:
non-destructively acquiring, using the detection device, a detection signal from an object arranged within an underground examination region; and
assigning the detection signal to a detection result based on a machine learning process in order to output the detection result and/or use this to adjust the detection device.

2. The method according to claim 1, further comprising:
in a teach-in phase of the machine learning process, dividing example values for the detection signal into different groups as a function of cluster formation of the example values.

3. The method according to claim 2, wherein the machine learning process uses a nearest neighbor classification to perform a division into the different groups.

4. The method according to claim 1, further comprising:
in a teach-in phase of the machine learning process, assigning example values for the detection signal at least one evaluation parameter in groups.

5. The method according to claim 1, wherein in a teach-in phase of the machine learning process, a dataset of example values for the detection signal consists at least substantially of user data.

6. The method according to claim 1, further comprising:
automatically selecting an operating mode of the detection device as a function of the machine learning process.

7. The method according to claim 1, comprising:
automatically selecting a zero reference for the detection device as a function of the machine learning process.

8. The method according to claim 1, further comprising:
outputting, using the detection device, an evaluation parameter of a group of example values of the detection signal, when a measured value of the detection signal is assigned to this group.

9. The method according to claim 8, further comprising:
assigning at least one underground parameter, at least one object parameter, at least one depth parameter, and/or at least one shape parameter to the evaluation parameter.

10. A detection device comprising:
at least one sensor unit configured to acquire a detection signal; and
at least one computing unit operably connected to the at least one sensor unit and configured to receive the detection signal, the at least one computing unit configured to perform the method according to claim 1.
